(19) United States
(12) Patent Application Publication
(10) Pub. No.: US 2015/0370673 A1
(43) Pub. Date: Dec. 24, 2015

(54) SYSTEM AND METHOD FOR PROVIDING A COMMUNICATION CHANNEL TO A POWER MANAGEMENT INTEGRATED CIRCUIT IN A PCD

(71) Applicant: QUALCOMM INCORPORATED, SAN DIEGO, CA (US)

(72) Inventors: Yudhishthira Kundu, BANGALORE (IN); Gordon Paul Lee, GILBERT, AZ (US); VICTOR WONG, SAN DIEGO, CA (US); Martin Russell Bigge, Farnborough (GB); Jaydeep Chokshi, SAN DIEGO, CA (US); Guruprasad Chinnabhandar, SAN DIEGO, CA (US)

(21) Appl. No.: 14/484,167

(22) Filed: Sep. 11, 2014

(30) Foreign Application Priority Data
Jun. 24, 2014 (IN) 3066/CHE/2014

(51) Int. Cl. G06F 11/26; G06F 11/07

(52) U.S. Cl. CPC G06F 11/26; G06F 11/0793; G06F 11/0751; G06F 11/079

(57) ABSTRACT

Communication channels among a connector port module, a debug interface module, and a power communication interface module may be established. Each of these elements may be part of a system-on-chip. The power communication interface module may be coupled to an integrated circuit, such as a power management integrated circuit. The connector port module may be coupled to a connector, in which the connector may facilitate connections between the PCD and one or more external devices, such as a testing/debugging device. The connector may comprise an SD connector. The connector may be monitored for a device present signal. If a device present signal has been detected, then it may be determined if a valid access code has been received for allowing access to communications within the PCD. If a valid access code is received, then a command may be issued to relinquish control of the integrated circuit from a master processor.

### PRIORITY AND RELATED APPLICATIONS STATEMENT

This application claims priority under 35 U.S.C. §119 to Indian Patent Application Serial No. 3066/CHE/2014, filed on Jun. 24, 2014, entitled, “SYSTEM AND METHOD FOR PROVIDING A COMMUNICATION CHANNEL TO A POWER MANAGEMENT INTEGRATED CIRCUIT IN A PCD” (Attorney Docket No. 145382IN1). The entire contents of this Indian Patent Application are hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

These devices may pose unique problems with respect to “debugging” or identifying system faults attributed to software and/or hardware errors. These problems for PCDs may be unique because of their small size and/or form factor. For example, system debugging for a PCD can be extremely difficult if normal communications within the PCD are lost as a result of a fault condition. In other words, if the user interface for a PCD becomes locked or “hung”, the operator may have no way of “debugging” the device since the normal communications via the operating system and user interface have become non-functional. Additionally, a hardware and/or software system fault may cause “hung” states during a mode (stage) where communication is not normally possible (such as booting or sleep).

Currently, there are no unobtrusive methods or systems available for interrogating configurations, operational conditions, or accessing other debugging schemes for PCDs in order to facilitate understanding of how one or more fault conditions have occurred and how to avoid or unlock the hung state for the device. In most conventional PCDs, access to the internal communication interface for monitoring and/or debugging the device typically requires disassembly of the product outer casing. And in some devices, it may be difficult or almost impossible to provide hardware (HW) modifications post manufacture and/or to provide secure HW designs that may couple (i.e. burying the communication interface traces) within the inner layers of PC boards within the devices.

Accordingly, what is needed in the art is an unobtrusive method and system which provides access to communication channels via an interface that does not require disassembly of a PCD. Another need is a method and system which can facilitate debugging while also maintaining security so that unauthorized access to hardware and/or software within the PCD may be prevented.

### SUMMARY OF THE DISCLOSURE

A method and system establish a communication channel with a power management integrated circuit of a portable computing device. The method and system may include establishing communication channels among a connector port module, a debug interface module, and a power communication interface module. Each of these elements may be part of a system on a chip. The power communication interface module may be coupled to the power management integrated circuit. The connector port module may be coupled to a connector, in which the connector may facilitate connections with external devices. The connector may be monitored for a device present signal.

If a device present signal has been detected, then it may be determined if a valid access code has been received for allowing access to communications within the PCD. If a valid access code has been received, then a command can be issued to relinquish control of the power management integrated circuit from a master processor.

A command may be issued to allow for direct communications between the connector and the power management integrated circuit. This command may be issued to a gate or switch. The direct communications comprise at least one of information about a fault condition and a corrective measure for preventing a subsequent fault condition. The connector may comprise a mechanical port that is capable of mating with a connector that follows a Secure Digital standard or any other type of connector.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a functional block diagram of a system for providing a communication channel to a power management integrated circuit of a wireless portable computing device (“PCD”);

FIG. 2A is a diagram of front view of an exemplary wireless portable computing device (“PCD”);

FIG. 2B is a diagram of a side view of the exemplary PCD of FIG. 2A having a connector positioned within a side wall/portion of the PCD;

FIG. 2C is a diagram of a rear view of an alternate exemplary embodiment of the PCD of FIG. 2A with the connector positioned on the rear of the housing of the PCD 101;

FIG. 3 is a functional block diagram illustrating an electronic packaging environment for an exemplary portable computing device (“PCD”) that may include PCD token storage; and

FIG. 4 is a flowchart illustrating a method for providing a communication channel to a power management integrated circuit of a wireless portable computing device (“PCD”).

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer, like a tablet PC, with a wireless connection or link.

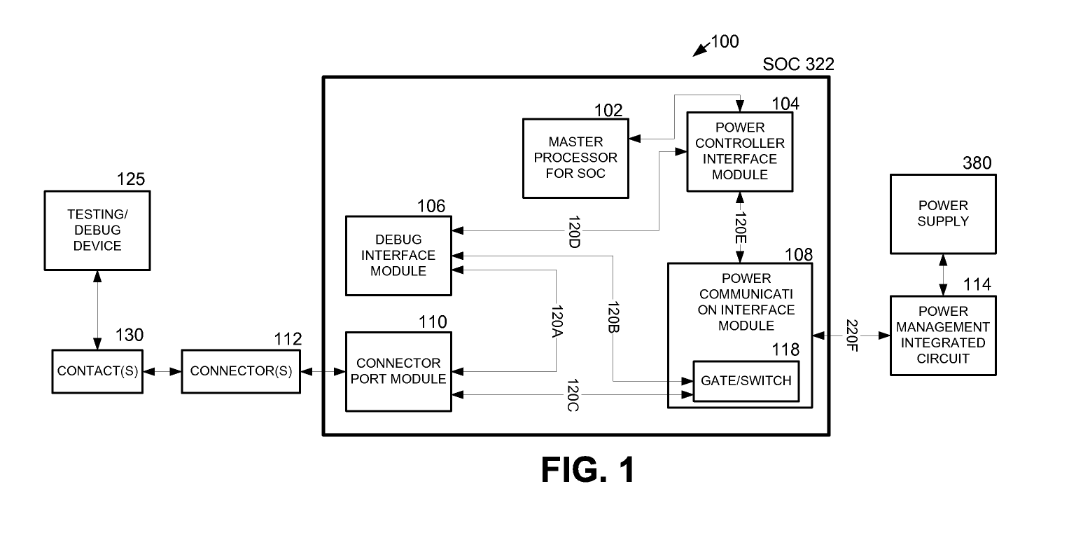

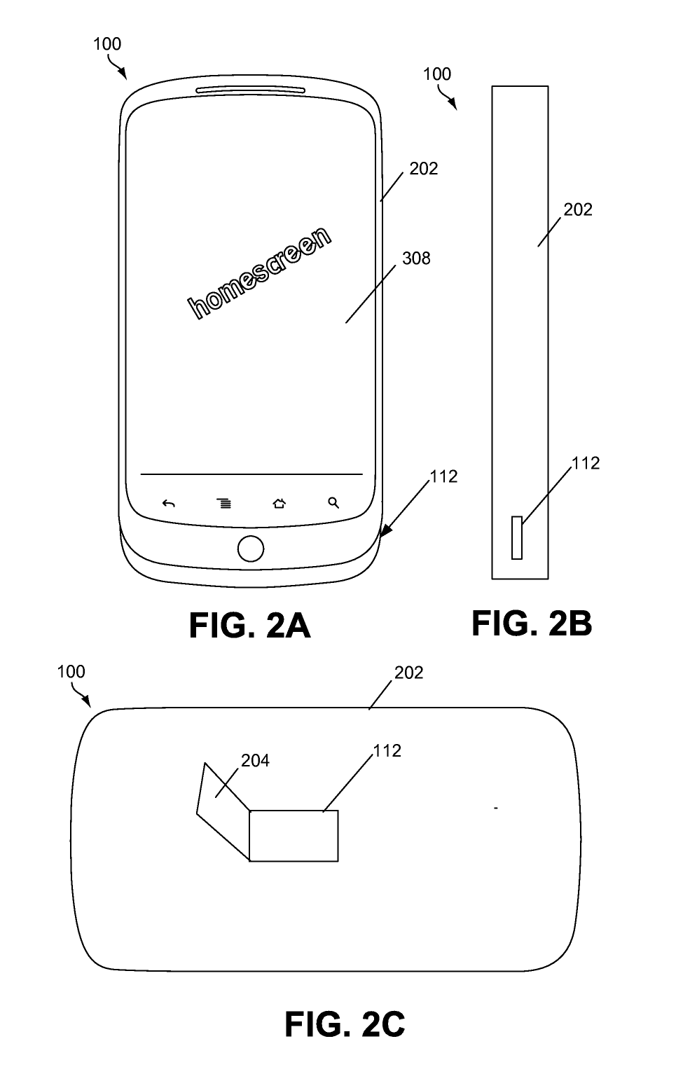

Referring initially to FIG. 1, this figure is a functional block diagram of a system 101 for providing a communication channel to a power manager integrated circuit (“PMIC”) 114 of a wireless portable computing device (“PCD”) 100 (see FIG. 2A). The system 101 may include a master processor 102, a power controller interface module 104, a debug interface module 106, a power communications interface module 108, a connector port module 110, a connector 112, and a power manager integrated circuit 114. The system may further include a testing or debugging device 125 and a power supply 380.

The master processor 102, the power controller interface module 104, the debug interface module 106, the power communications interface module 108, the connector port module 110, and the power manager integrated circuit 114 may form a system-on-chip (“SoC”) 322 as understood by one of ordinary skill in the art. In other words, these elements enumerated above and illustrated in FIG. 1 all reside on a single chip or silicon platform. Meanwhile, the power manager integrated circuit 114, connector 112, and power supply are located “off-chip” relative to the SoC 322 but within a hardware casing or shell 202 (see FIG. 2) of the PCD 100. The testing/debugging device 125 is a separate hardware unit/device relative to the PCD 100 which resides outside of the PCD casing 202 and communicates with the PCD 100 via the connector 112.

The master processor 102 may comprise a central processing unit (“CPU”). The CPU may have multiple cores as described below. The master processor 102 may execute one or more software (“SW”) programs, such as application programs that are routinely executed by mobile telephones or other portable computing devices, like tablet PCs, PDAs and other similar devices.

The master processor 102 may communicate and issue commands to the power controller interface module 104. The power controller interface module 104 may relay the communications from the master processor 102 to the power communications interface module 108 and from the power communications interface module 108 to the master processor via a communication channel or bus 120E. The term “channel” as used in this description may include a single as well as a plurality of physical electrical lines within a SoC that are typically used inter-hardware communications.

The power controller interface module 104 may translate the communications to/from the master processor 102 if the communications for the power communications interface module 108 and/or the power manager integrated circuit 114 are unique and/or follow a communications standard for power communications.

The power communications interface module 108 may comprise hardware such as a gate or switch 118 as well as pads, traces, and other discrete circuitry/hardware elements not illustrated for coupling to a communication channel or bus 120F which is coupled to the power management integrated circuit. Further details of the gate/switch 118 will be described below.

The power manager integrated circuit 114 is usually responsible for managing all power demands of the SoC 322 as well as any additional SoCs not illustrated and other hardware elements within the PCD 100. The power manager integrated circuit 114 may track the sources/causes of fault conditions that may occur within the PCD 100.

During operation of the PCD 100, the master processor 102 has an exclusive communication channel or link with the power manager integrated circuit 114 via the power controller interface module 104, communication channel/bus 120E, power communication interface module 108, and communication channel/bus 120F. When the master processor 102 experiences a fault condition due to HW or SW or any combination thereof, the PCD 100 may experience a hang-up where the user interface for the PCD 100 becomes “locked” or “frozen.” It is at least this condition that the system 100 and method are trying to resolve such that an external device, like a testing/debugging device 125 outside of the PCD 100 may establish communications with the power management integrated circuit (“PMIC”) 114 in order to determine what SW and/or HW units have failed or help create the fault condition of the PCD 100.

As one way to interrupt the control the master processor 102 may have over the PMIC 114 during a fault or hang-up condition, the debug interface module 106 may issue a command along a communication channel 120D to the power controller interface module 104 to stop or block the communications originating from the master processor 102. The debug interface module 106 may issue this command only when certain conditions/parameters are met which will be described below.

The debug interface module 106 may comprise hardware, software, firmware or a combination thereof. The debug interface module 106 usually comprises hardware that includes logic to determine if an interrupt command should be issued along the communication channel 120D to the power controller interface module 104. The debug interface module 106 may sense the presence of a testing/debugging device 125 when the testing/debugging device 125 having contacts 130 is coupled to a connector 112. The connector 112, as described above, is off-chip relative to the SoC 322 and is coupled to a connection port module 110. The connection port module 110 located on the SoC 322 may comprise pads, traces, and other discrete circuitry/hardware elements not illustrated for coupling to a communication channel or bus 120A which is in turn coupled to the debug interface module 106.

The connector 112 may comprise a mechanical port that is sized to receive Secure Digital (“SD”) non-volatile memory cards for use in portable computing devices (“PCDs”), such as mobile phones, digital cameras, GPS navigation devices, and tablet computers. As of this writing the Secure Digital format includes four card families available in three different form factors. The four families are the original Standard-Capacity (“SDSC”), the Secure Digital High-Capacity (“SDHC”), the Secure Digital eXtended-Capacity (“SDXC”), and the Secure Digital Input/Output (“SDIO”), which combines input/output functions with data storage. The three form factors are the original size, the “mini” size, and the “micro” size.

The connector 112 may comprise a mechanical port that can mate with anyone of the four families and form factors for Secure Digital standard devices described above. Further, the connector 112 may also be customized with unique dimensions should an original equipment manufacturer (“OEM”) desire a port that has a unique size and/or mechanical configuration for an OEM debugging/testing device 125.

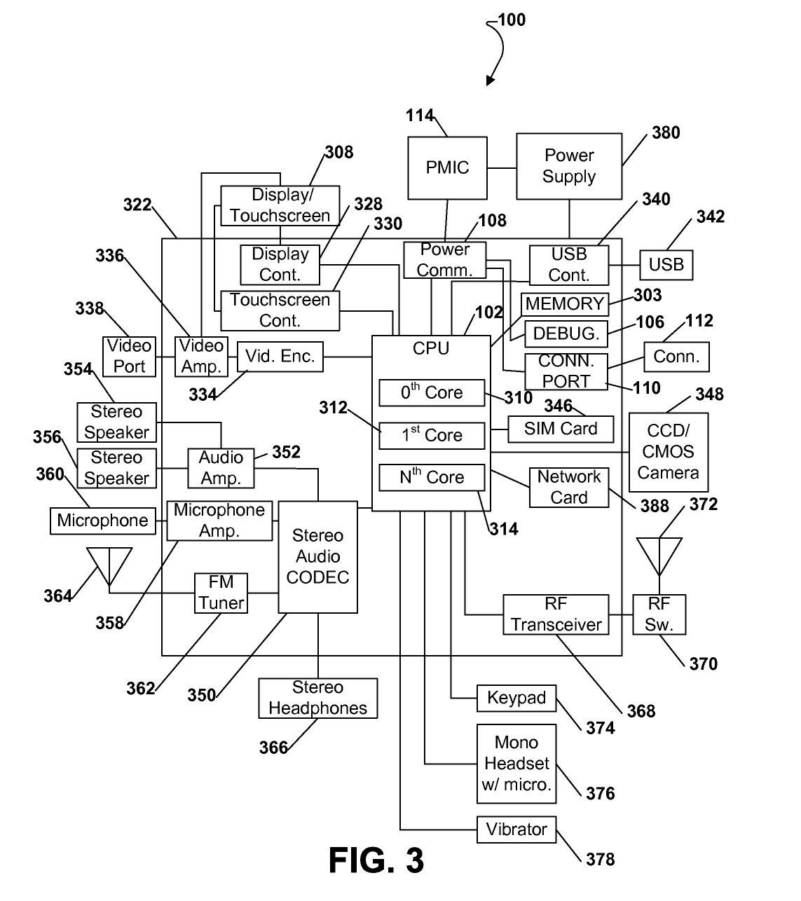

The connector 112 may comprise any type of connector as an alternative to SD type of connectors. Other connectors include, but are not limited to, audio connectors, subscriber identity module (“SIM”) connectors 346, universal serial bus (“USB”) connectors 342, Universal Integrated Circuit Card (“UICC”) connectors, just to name a few. This means that connector 112 could take the form of connectors 342, 246 of FIG. 3 or connectors 342, 346 may be modified to have communication channels coupled to the power communication interface module 108 of FIG. 3 as understood by one of ordinary skill in the art.

The debug interface module 106 may comprise logic that determines if the debugging/testing device 125 having contacts 130 is coupled to the connector 112. Once the debug interface module 106 determines that the debugging/testing device 125 is present, its logic may then determine if the debugging/testing device 125 has provided the correct access code for gaining access to the power manager integrated circuit (“PMIC”) 114. The access code may comprise digits of any length as well as any combination of alphanumeric characters, as understood by one of ordinary skill in the art.

If the debug interface module 106 supplies the correct access code to gain access to the PMIC 114, then the debug interface module 106 may issue an interrupt command along the communication channel 120D to the power controller interface module 104 in order to relinquish control of the PMIC 114 from the master processor 102. The debug interface module 106 may also issue a command along the communication channel 120B to open the gate/switch 118 of the power communication interface module 108.

The gate/switch 118 prevents communication signals flowing between the connector port module 110 and the power communication interface module 108 along the communication channel 120C. When it is determined by the debug interface module 106 that the testing/debugging device should have full and direct access the PMIC 114, then the gate/switch 118 may be “opened” to allow direct communications to and from the connector port module 110 along direct communication channel 120C to flow.

While a direct communication channel 120B is illustrated between the debug interface module 106 and gate/switch 118, it is possible in other exemplary embodiments for the power controller interface module 104 to have control of the gate/switch. In such an exemplary embodiment, the debug interface module 106 may issue one or more “open-gate” commands to the power controller interface module 104 along communication channel 120D. The power controller interface module 104 may then relay the “open-gate” commands along the communication channel 120E to the power communication interface module 108. Of course, other electronic packaging/communication schemes are possible and are within the scope of this disclosure as understood to one of ordinary skill in the art.

Once the gate/switch 118 is opened to allow for direct communications to occur between the testing/debugging device 125 and the PMIC 114 via the communication channel 120C and the connection port module 110 and power communication interface module 108, then the testing/debugging device 125 may collect important debugging/fault information from the PMIC 114. Is some exemplary embodiments, the testing/debugging device 125 may issue corrective signals/commands for helping remove the PCD 100 from a fault, hung, or frozen status. The testing/debugging device 125 may comprise an off-the-shelf unit or a customized device made by OEMs of the PCD 100.

FIG. 2A is a diagram of front view of an exemplary wireless portable computing device (“PCD”) 100 having a display screen 308. The exemplary wireless PCD 100 of FIG. 2A is a mobile phone which has an outer shell/casing or housing 202. The housing 202 is usually made of plastic but other materials or a combination of materials, such as, but not limited to, metal and plastic may be employed. The housing 202 may have an aperture for the connector 112 as illustrated in FIGS. 2B and 2C.

FIG. 2B is a diagram of a side view of the exemplary PCD 100 of FIG. 2A having the connector 112 positioned within a side wall/portion of the PCD 100. The connector 112 may be “female” for receiving contacts of a “male” connector of the testing/debugging device 125 of FIG. 1. An access door/flap (not illustrated in FIG. 2B) may be provided over the connector 112. While the connector 112 is illustrated at a far end position relative to the length dimension of the PCD 100 in FIG. 2B, the connector 112 may be placed at other positions along the length as desired and as understood by one of ordinary skill in the art.

FIG. 2C is a diagram of a rear view of an alternate exemplary embodiment of the PCD of FIG. 2A with the connector 112 positioned on the rear of the housing 202 of the PCD 101. In this exemplary embodiment, the connector 112 may be provided with an access door/flap 204 for protecting the contacts of the connector 112. While the connector 112 is depicted in this exemplary embodiment in the geometric center of the rear housing 202, the connector 112 may be placed at other positions along the rear housing 202 as desired and as understood by one of ordinary skill in the art.

As apparent to one of ordinary skill in the art, the connector 112 may still receive a non-volatile memory unit, such as a conventional SD card (not illustrated) when the testing/debugging device 125 is not needed. This means that the connector 112 may still remain a fully functional receptacle for non-volatile memory units as desired by the operator of the PCD 100.

Referring to FIG. 3, an exemplary, non-limiting aspect of a portable computing device (“PCD”) is shown and is generally designated 100. As shown, the PCD 100 includes an on-chip system 322 that includes a multicore CPU 102. The multicore CPU 102 may include a zeroth core 310, a first core 312, and an Nth core 314.

As illustrated in FIG. 3, a display controller 328 and a touch screen controller 330 are coupled to the multicore CPU 102. In turn, a display 308 external to the on-chip system 322 is coupled to the display controller 328 and the touch screen controller 330. The PMIC 114 may be coupled to the CPU 102 via the power communication interface module 108 as described above. The PMIC 114 may support functions that work in combination with the debug interface module 106 as described above. The debug interface module 106 may comprise software and/or hardware and/or firmware as understood by one of ordinary skill in the art.

The power communication interface module 108 in addition to the debug interface module 106 is also coupled to the connector port module 110. The connector port module 110, as described above, is coupled to a connector 112 which may be “off-chip” relative to the connector port module 106 and SoC 322.

FIG. 3 further shows that a video encoder 334, e.g., a phase alternating line (“PAL”) encoder, a sequential color a memoire (“SECAM”) encoder, or a national television system(s) committee “(NTSC”) encoder, is coupled to the multicore CPU 102. Further, a video amplifier 336 is coupled to the video encoder 334 and the touch screen display 308. Also, a video port 338 is coupled to the video amplifier 336. As shown in FIG. 3, a universal serial bus (“USB”) controller 340 is coupled to the multicore CPU 102. Also, a USB port 342 is coupled to the USB controller 340. Memory 303 and a subscriber identity module (“SIM”) card 346 may also be coupled to the multicore CPU 102.

Further, as shown in FIG. 3, a camera 348 may be coupled to the multicore CPU 302. In an exemplary aspect, the camera 348 is a charge-coupled device (“CCD”) camera or a complementary metal-oxide semiconductor (“CMOS”) camera.

As further illustrated in FIG. 3, a stereo audio coder-decoder (“CODEC”) 350 may be coupled to the multicore CPU 102. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (“FM”) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further illustrates that a radio frequency (RF) transceiver 368 may be coupled to the multicore CPU 102. An RF switch 370 may be coupled to the RF transceiver 368 and an RF antenna 372. As shown in FIG. 3, a keypad 374 may be coupled to the multicore CPU 102. Also, a mono headset 376 (with a microphone) may be coupled to the multicore CPU 102. Further, a vibrator device 378 may be coupled to the multicore CPU 102. FIG. 3 also shows that a power supply 380 may be coupled to the on-chip system 322 as well as the PMIC 114.

In a particular aspect, the power supply 380 is a direct current (DC) power supply that provides power to the various components of the PCD 100 that require power. Further, in a particular aspect, the power supply may comprise a rechargeable DC battery or a DC power supply that is derived from an alternating current (AC) to DC transformer that is connected to an AC power source.

FIG. 3 further shows that the PCD 100 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the display 308, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator device 378, the PMIC 114, the connector 112, and the power supply 380 are external to the on-chip system 322. Meanwhile, the CPU 102, power communication interface module 108, debug interface module 106, and connector port module 110 all reside on the SoC 322.

In a particular aspect, one or more of the method steps described herein may be stored in the memory 303 as well as in the debug interface module 106, and other storage devices as computer program instructions. These instructions may be executed by the multicore CPU 102, power communication interface module 108, connector port module 110, and debug interface module 106 in order to perform the methods described herein. Further, the multicore CPU 102, power communication interface module 108, connector port module 110, and debug interface module 106, other storage devices, and memory 303 of the PCD 100, or a combination thereof may serve as a means for executing one or more of the method steps described herein.

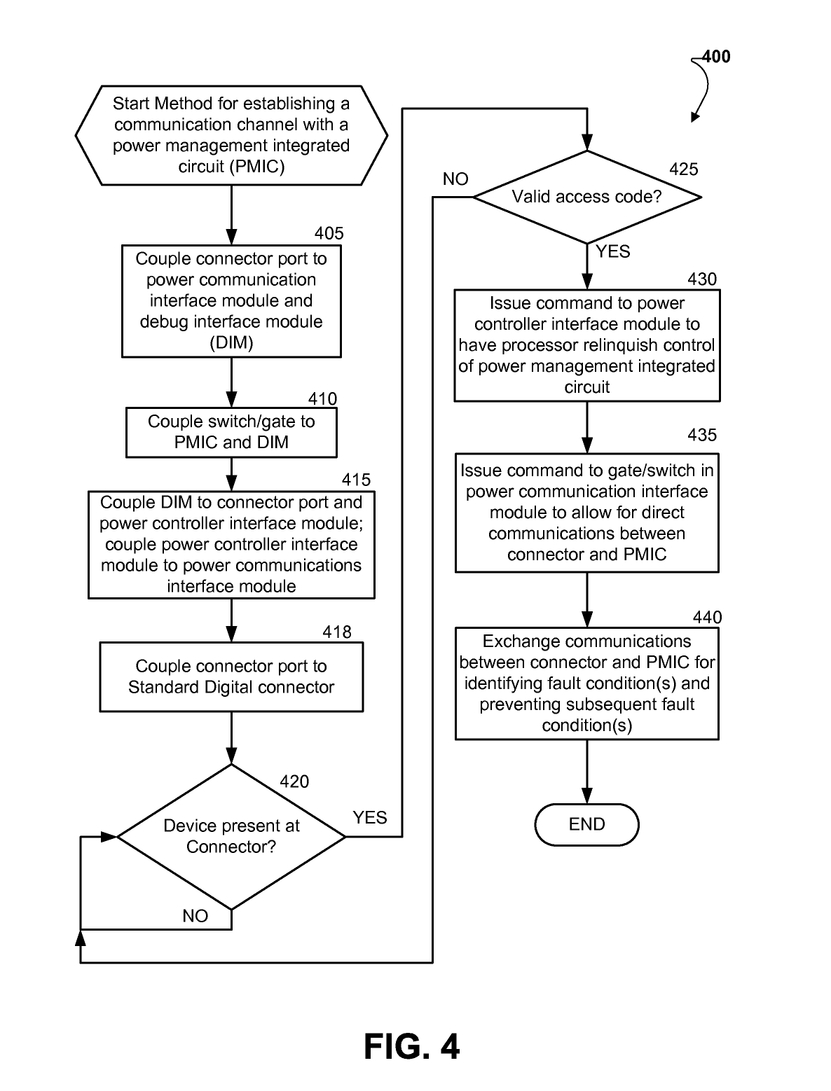

FIG. 4 is a flowchart illustrating a method 400 for providing a communication channel to a power management integrated circuit 114 of a wireless portable computing device (“PCD”) 100.

Block 405 is the first step of method 400. In block 400, a connector port module 110 may be coupled to the power communication interface module 108 and the debug interface module 106. With respect to the power communication interface module 108, the connector port module 110 may be coupled to a gate/switch of the power communication interface module 108.

Next, in block 410, the gate/switch 118 of the power communication interface module 108 may be coupled to the debug interface module 106 and the power management integrated circuit 114. Subsequently, in block 415, the debug interface module 106 may be coupled to the connector port module 110 and the power controller interface module 104. The power controller interface module 105 may also be coupled to the power communication interface module 108 in block 415.

In block 418, the connector port module may be coupled to a connector 112 that facilitates connections with external devices, such as the testing/debugging device 125, relative to the PCD 100. As noted previously, the connector 112 may comprise a mechanical port that can mate with anyone of the four families and form factors for devices according to the Secure Digital standard mentioned above.

The sequence or order of blocks 405 through 418 may be switched as desired without departing from the scope of this disclosure as understood by one of ordinary skill in the art. The order or sequence in which the communication channels are established is not critical.

In decision block 420, the debug interface module 106 may determine if the testing/debugging device 125 of FIG. 1 has been coupled to the connector 112. If the inquiry to decision block 420 is negative, then the process 400 may follow the “NO” branch and continue back to this step and repeat for checking if the device 125 has connected yet to the PCD 100.

If the inquiry to decision block 420 is positive, then the “YES” branch may be followed to decision block 425. In decision block 425, the debug interface module 106 may determine if the device 125 which has been connected to the PCD 100 via connector 112 has supplied a valid access or security code. As noted previously, the access code may comprise digits of any length as well as any combination of alphanumeric characters, as understood by one of ordinary skill in the art.

If the inquiry to decision block 425 is negative, then the “NO” branch may be followed back to the beginning of decision block 420. If the inquiry to decision block 425 is positive, then the “YES” branch may be followed to block 430.

In block 430, the debug interface module 106 may issue a command along communication channel 120D to the power controller interface module 104 to relinquish control of the power management integrated circuit 114 from the master processor 102. Next, in block 435, the debug interface module 106 may issue a command to the gate/switch 108 of the power communication interface module 108 to permit direct communications with the connector port module 110 that receives signals directly from the testing/debugging device 125.

Then in block 440 communications between the power management integrated circuit 114 and the testing/debugging device 125 may be exchanged along the communication channel 120C via the power communication interface module 108 and the connector port module 110 residing on the SoC 322. These communications may comprise information about a system fault or hang condition. The communications may also comprise one or more corrective measures to prevent subsequent fault conditions. The method 400 may then end.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the scope of the disclosure, as defined by the following claims.

What is claimed is:

1. A method for providing a communication channel to a power management integrated circuit of a portable computing device (“PCD”), the method comprising:
establishing communication channels among a connector port module, a debug interface module, and a power communication interface module which are part of a system on a chip, the power communication interface module being coupled to an integrated circuit;
establishing communications between the connector port module and a connector;
determining if a device present signal has been detected at the connector;
if a device present signal has been detected, then determining if a valid access code has been received; and
if a valid access code has been received, then issuing a command to relinquish control of the integrated circuit.

2. The method of claim 1, further comprising issuing a command to allow for direct communications between the connector and the integrated circuit.

3. The method of claim 2, wherein the command to allow direct communications between the connector and the integrated circuit is issued to a switch within the power communication interface module.

4. The method of claim 1, wherein the direct communications comprise at least one of information about a fault condition and a corrective measure for preventing a subsequent fault condition.

5. The method of claim 1, wherein establishing communications between the connector port module and the connector further comprises establishing communications with a connector that comprises a mechanical port is capable of mating with a connector that includes at least one of a connector that follows a Secure Digital standard, an audio connector, a subscriber identity module (“SIM”) connector, a universal serial bus (“USB”) connector, and a Universal Integrated Circuit Card (“UICC”) connector.

6. The method of claim 5, wherein the connector comprises a mechanical port that is capable of mating with at least one of Secure Digital Standard-Capacity (“SDSC”) connector, a Secure Digital High-Capacity (“SDHC”) connector, a Secure Digital eXtended-Capacity (“SDXC”) connector, and a Secure Digital Input/Output (“SDIO”) connector.

7. The method of claim 1, further comprises coupling the power controller interface module to a processor residing on the chip.

8. The method of claim 1, wherein the integrated circuit comprises a power management integrated circuit, the method further comprising coupling the power management integrated circuit to a power supply.

9. The method of claim 1, wherein the power supply comprises at least one of a rechargeable direct current (DC) battery and a DC power supply that is derived from an alternating current (AC) to DC transformer that is connected to an AC power source.

10. The method of claim 1, wherein the portable computing device comprises at least one of a mobile telephone, a personal digital assistant, a pager, a smartphone, a navigation device, a tablet PC, and a hand-held computer with a wireless connection or link.

11. A computer system for providing a communication channel to a power management integrated circuit of a portable computing device (“PCD”), the computer system comprising:
a processor operable for:
establishing communication channels among a connector port module, a debug interface module, and a power communication interface module which are part of a system on a chip, the power communication interface module being coupled to an integrated circuit;
establishing communications between the connector port module and a connector;
determining if a device present signal has been detected at the connector;
determining if a valid access code has been received if a device present signal has been detected; and
issuing a command to relinquish control of the integrated circuit if a valid access code has been received.

12. The computer system of claim 11, wherein the processor is further operable for issuing a command to allow for direct communications between the connector and the integrated circuit.

13. The computer system of claim 12, wherein the command to allow direct communications between the connector and the integrated circuit is issued to a switch within the power communication interface module.

14. The computer system of claim 11, wherein the direct communications comprise at least one of information about a fault condition and a corrective measure for preventing a subsequent fault condition.

15. The computer system of claim 11, wherein establishing communications between the connector port module and the connector further comprises establishing communications with a connector that comprises a mechanical port is capable of mating with a connector that includes at least one of a connector that follows a Secure Digital standard, an audio connector, a subscriber identity module (“SIM”) connector, a universal serial bus (“USB”) connector, and a Universal Integrated Circuit Card (“UICC”) connector.

16. A computer system for providing a communication channel to a power management integrated circuit of a portable computing device (“PCD”), the computer system comprising:
means for establishing communication channels among a connector port module, a debug interface module, and a power communication interface module which are part of a system on a chip, the power communication interface module being coupled to an integrated circuit;
means for establishing communications between the connector port module and a connector;
means for determining if a device present signal has been detected at the connector;
means for determining if a valid access code has been received if a device present signal has been detected; and
means for issuing a command to relinquish control of the integrated circuit if a valid access code has been received.

17. The computer system of claim 16, further comprising means for issuing a command to allow for direct communications between the connector and the integrated circuit.

18. The computer system of claim 17, wherein the command to allow direct communications between the connector and the integrated circuit is issued to a switch within the power communication interface module.

19. The computer system of claim 16, wherein the direct communications comprise at least one of information about a fault condition and a corrective measure for preventing a subsequent fault condition.

20. The computer system of claim 16, wherein the means for establishing communications between the connector port module and the connector further comprises means for establishing communications with a connector that comprises a mechanical port is capable of mating with a connector that includes at least one of a connector that follows a Secure Digital standard, an audio connector, a subscriber identity module (“SIM”) connector, a universal serial bus (“USB”) connector, and a Universal Integrated Circuit Card (“UICC”) connector.
